(19) United States
(12) Patent Application Publication
(10) Pub. No.: US 2003/0112840 A1
(43) Pub. Date: Jun. 19, 2003

(54) High power laser carrier

(76) Inventors: Claudia Kowanda, Zurich (CH); Bernd Valk, Unterlunkhofen (CH)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/026,150

(22) Filed: Dec. 19, 2001

(51) Int. Cl. H01S 3/04

(52) U.S. Cl. 372/36

(57) ABSTRACT

A laser carrier baseplate and method of making the same is described. The laser carrier baseplate having high thermal conductivity is used for receiving a coupling apparatus for optically coupling a high power laser to an optical fiber by means of laser beam welding. The location of weld joints required to secure the apparatus to the baseplate is first identified along with the depth and diameter of the weld joints where the apparatus is to be secured. one or more low thermal conductivity inserts are placed and secured at each weld joint.

This invention relates to carrier baseplates for lasers, but more particularly to a carrier baseplate for receiving a coupling apparatus for optically coupling a high power laser to an optical fibre.

### BACKGROUND OF THE INVENTION

It is known that semiconductor diodes generate heat while emitting optical power. With increased heat at the laser chip comes a decrease of the optical power output. The reliability of these devices decreases with an increase in temperature. In order to keep the loss of optical power to a minimum, a good heat transfer from the laser chip to a heat sink is required. An indication of the level of heat transfer available is the simultaneous heat spread offered across the surface of the heat sink. This enables the heat sink to efficiently remove or dissipate heat away from the laser chip. One of the problem faced by designers of carriers used for laser/fiber interface alignment, is being able to offer a highly reliable method for optically coupling an optical fiber to an injection laser. The goal is to minimize misalignments resulting from the solidification of scouring agents and from subsequent creep and/or thermal relaxation. Using materials with low thermal expansion coefficients to support the carrier and the elements for the alignment of optical fibres, the position and alignment of the fiber and laser should be substantially independent of temperature changes. As an example, the alignment between a fibre and laser can be required to be held constant to within about 0.11 μm over a temperature range of −40 degrees C. to +85 degrees C. and through several hundred thermal shocks over the same temperature range. An example of a method and a jig for coupling optical fibres to lasers is described in U.S. Pat. No. 5,570,444.

Although the use of low expansion material improves stability of laser/fiber interfaces, it will also work against providing dissipation of the heat generated by the laser. A baseplate material of CuW (Copper-Tungsten) composite could be used, but it's thermal conductivity properties makes alignment of the laser to the fiber difficult to achieve.

Normally, in order to provide a secure alignment between fiber and laser on a baseplate, laser welding is used. Generally, welding requires materials with low thermal conductivity but as indicated previously, such material will work against providing heat dissipation to cool the laser carrier.

A need therefore exist for a carrier design able to quickly and efficiently dissipate heat generated by high power lasers while providing a stable platform for fiber to laser alignment.

### SUMMARY OF THE INVENTION

According to a first aspect of the invention, there is provided a method of preparing a laser carrier baseplate having high thermal conductivity properties for receiving a coupling apparatus for optically coupling a high power laser to an optical fiber by means of laser beam welding. The location, depth and diameter of weld joints required to secure said apparatus to said baseplate are first identified. One or more low thermal conductivity insert is placed and secured on said baseplate to receive each weld joint.

According to a second aspect of the invention, there is provided a laser carrier baseplate for receiving and securing an apparatus for optically coupling a high power laser to an optical fiber by means of laser beam welding. The carrier baseplate has one or more receptacles for receiving low thermal conductivity inserts located and sized according to the depth and diameter of weld joints required for securing the apparatus to the laser carrier baseplate.

In another aspect of the invention, the carrier baseplate and inserts is made using a functionally graded manufacturing process

In yet another aspect of the invention, the carrier baseplate is attached to a heat sink, such as a Thermo Electric Cooler (TEC) or Peltier element.

In a further aspect of the invention, the low thermal conductivity inserts are made of KOVAR®.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The invention and its embodiments thereof will be described in conjunction with the accompanying drawings in which:

FIG. 1 is a schematic diagram of an apparatus for coupling an optical fiber to an injection laser according to the prior art;

FIGS. 2a and 2b are schematics of a carrier baseplate used in the prior art design of FIG. 1;

FIG. 3 is a schematic of an improved baseplate according to a first embodiment of the present invention;

FIG. 4 is a schematic illustrating the flow of heat in a prior art carrier design;

FIG. 5 is a schematic diagram illustrating the use of low thermal conductivity inserts according to another embodiment of the present invention; and

FIG. 6 is a schematic illustrating the production process for forming carrier baseplate design with low thermal conductivity inserts elements of FIG. 5.

### DETAILED DESCRIPTION OF A PREFERRED EMBODIMENT

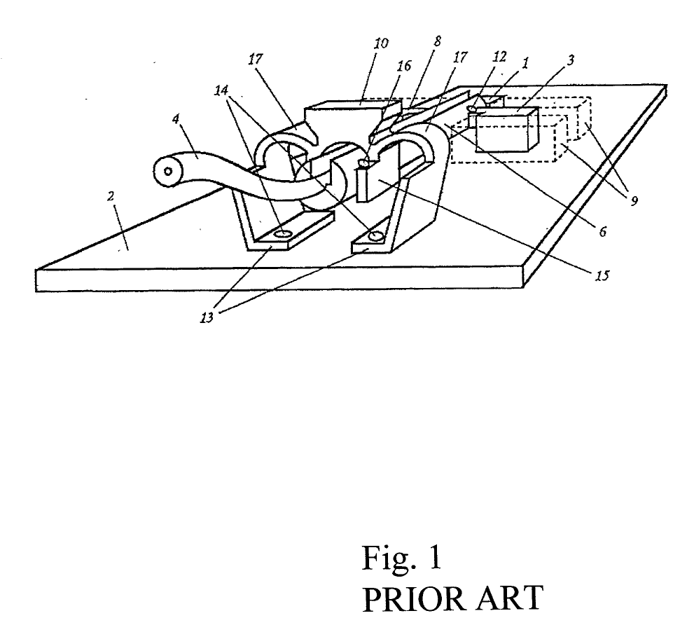

Making reference to FIG. 1, we have show n a prior art apparatus for optically coupling optical fibers to injection lasers. The apparatus is laser beam welded to a low thermal conductive substrate 2, the end of an optical fibre is held in alignment with an injection laser by securing the fibre 4 to a slotted rod 6 whose end nearer the injection laser is then laser beam welded to a pair of slide members 9 that have previously been secured by laser beam welding to leave a precisely dimensioned small gap between the support and slide members. The smallness of the gap minimises displacement of the fibre during the laser beam welding process. The end of the support member remote from the injection laser is secured by laser beam welding to a plastically deformable saddle 10. By making the substrate 2, the slotted rod 6, the slide members 8, their co-operating runner blocks 9, and the deformable saddle 10, all of the same low thermal expansion material, such as KOVAR®, the precise positioning of the end of the optical fibre 4 relative to the laser should be substantially independent of temperature.

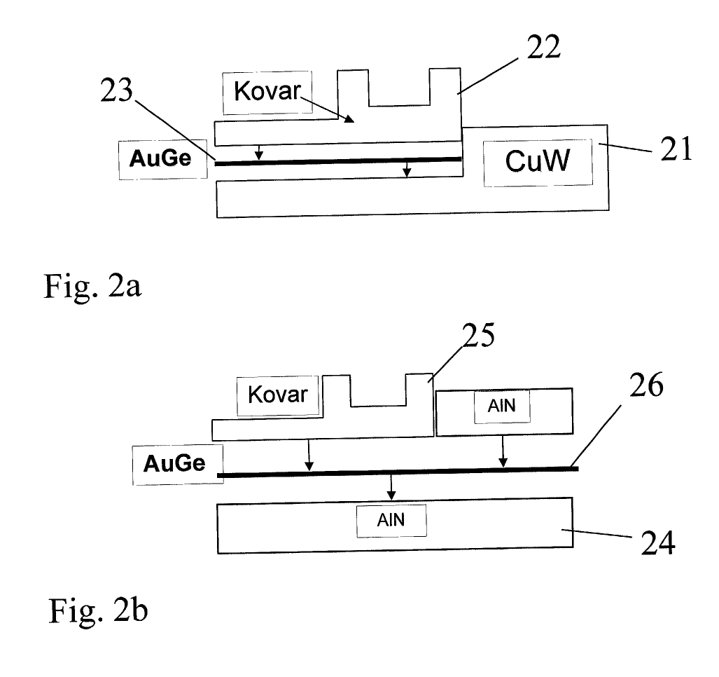

Unfortunately, as indicated above, this and other types of carrier designs are unsuitable for high power lasers, which generate heat while emitting optical power. Any increase in heat levels leads to a decrease in optical power output unless a good heat transfer from the laser chip to a heat sink is provided. In addition, continuous operation of the laser at high temperature also leads to lower reliability. Accordingly, while the above-identified design provides a good low thermal expansion surface for welding components, this type of low thermal conductivity surface works against the need to provide a good homogeneous and isotropic heat transfer from the heat source (laser chip) down to the heat sink or Thermal Electric Cooler. In this architecture, a good homogeneous and isotropic heat transfer can only be achieved by providing the necessary capacity to transport the heat generated by a high power laser away therefrom. A homogeneous and isotropic heat transfer should be available if the whole carrier is made out of one material, no matter if it is a material with low or high thermal conductivity. A non-homogeneous and anisotropic heat transfer occurs when the thermal conductivity parameters change during the thermal path from the heat source (chip) to the cooler (TEC). Changing thermal conductivity parameters are achieved by using different materials (KOVAR®—AuGe—CuW or KOVAR®—AuGe—AlN (Aluminum nitride)) as it is shown in FIG. 2a and 2b.

A known carrier design is shown in FIGS. 2a and 2b. In FIG. 2a, the carrier assembly is made of a high thermal conductivity baseplate 21, such as Copper-Tungsten (CuW) and a low thermal conductivity weld platform 22, made of KOVAR® for example. The weld platform 22 is soldered to the baseplate 21 by means of a Au—Ge solder 23. In FIG. 2b, the carrier assembly is made of a high thermal conductivity material baseplate (AIN) 24, a KOVAR® weld platform 25 and a Au—Ge solder 26.

The carrier designs shown in FIGS. 2a and 2b contain a solder interface between the baseplate and the weld platform. It is known that solder interfaces are affected by heat. For example, during the soldering process, large volumes of voids and de-laminated areas can arise. This can lead to an increase in heat resistance, i.e. a decrease in heat transfer.

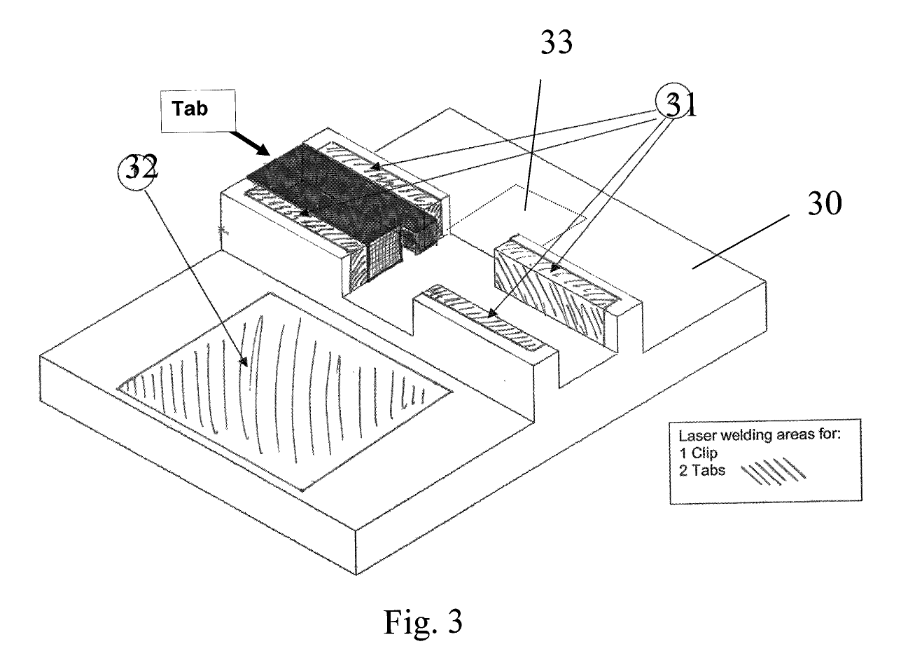

Referring now to FIG. 3, we have shown a carrier design according to one embodiment of the present invention. The carrier makes use of a combination of two materials for providing high thermal conductivity for optimized heat transfer (low thermal resistance) from a laser chip to a heat sink and low thermal conductivity for fixing an optical fiber and other components by means of laser beam welding. In particular, the carrier design makes use of a high thermal conductivity baseplate 30 such as Copper-Tungsten (CuW) and low thermal conductivity or heat insulating inserts 31 and 32 such as KOVAR® to enable laser beam welding of optical fiber fixing components. The KOVAR® inserts are secured to the CuW body by means of brazing (not shown). With this carrier design, a laser chip on a sub mount (which should be also high thermal conductivity material) identified by broken line 33 is seated directly on the CuW baseplate 30, thus providing the laser chip with a heat dissipation which is homogeneous in all directions.

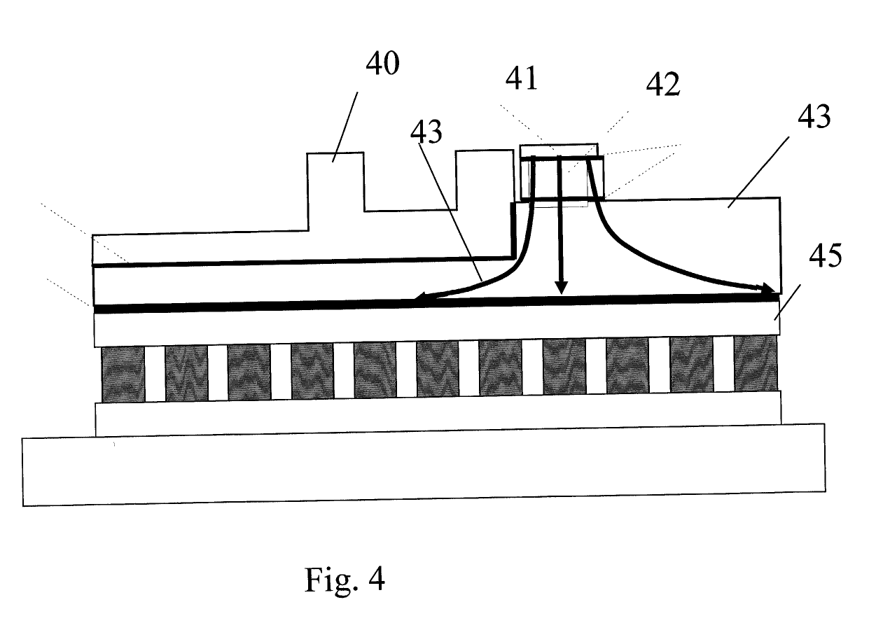

Heat dissipation for carrier designs of FIGS. 2a and 2b could not be achieved in view of the thermal barrier created by the KOVAR® weld platform. This is illustrated in FIG. 4, wherein the KOVAR® weld platform 40, which sits adjacent the laser chip 41 and sub mount 42 deflects the flow of heat 43 into the baseplate 44 and heat sink (e.g. Thermo Electric Cooler—TEC) 45. Because the spreading angle of the heat flow is reduced, less heat can be transported away from the heat source, in this case, the laser chip 41.

Referring back to FIG. 3, the area beneath the laser chip and sub mount assembly 33 is free from thermal barriers thus, optimized heat transfer is achieved into the CuW baseplate 30. With the carrier design of the present invention, the optical aligning apparatus can still be used. However, the apparatus is laser beam welded to inserts 31 and 32 made of a low thermal conductivity material. Similarly, part of the co-operating runner blocks 9 are provided with inserts 31 made of low thermal coefficient material. The slide members 8 are welded to the portions of the co-operating runner blocks 9 made of low thermal conductivity material. The end of the support member 6 remote from the injection laser is secured by laser beam welding to a plastically deformable saddle 10. In the embodiment of FIG. 3, the saddle 10 of FIG. 1 is now laser beam welded to the insert 32. In this embodiment, the slotted rod 6, the slide members 8, their co-operating runner blocks 9, and the deformable saddle 10, are all made of the same low thermal expansion material, such as KOVAR®. However, a substrate made of more suitable thermal conductive material such as CuW can be used without affecting the precise positioning of the end of the optical fibre 4 relative to the laser during temperature changes.

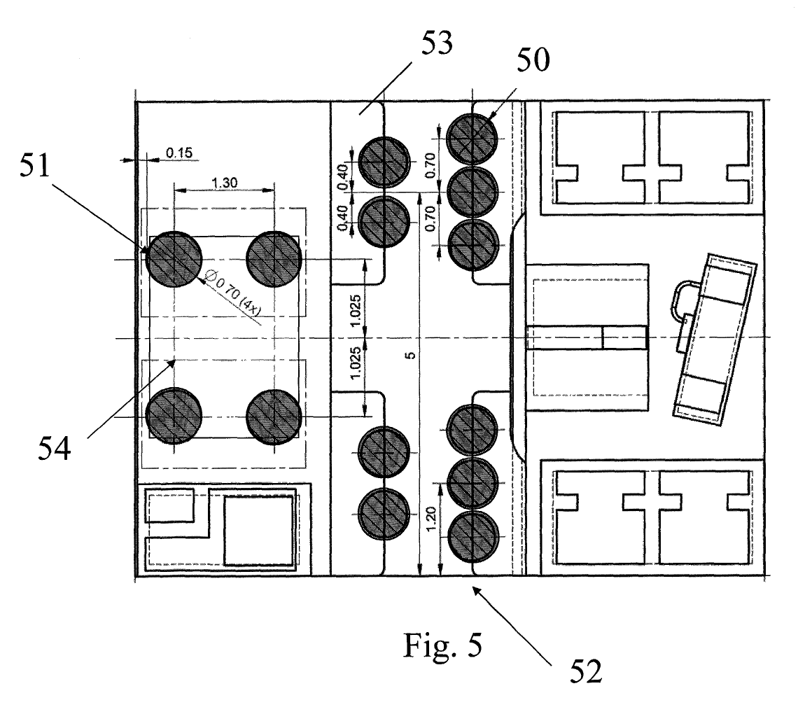

Referring now to FIG. 5, we have shown a preferred embodiment of the invention, wherein cylindrical inserts 50 made of low expansion material, such as KOVAR® are used at each welding point required for securing the optical aligning apparatus of FIG. 1. In the case of the deformable saddle 10, 4 weld joints are used to secure the deformable saddle to 4 KOVAR® cylindrical inserts 51. Similarly, the slide members 8 (FIG. 1) are secured to the co-operating runner blocks 53 by means of 5 weld joints at each runner block. The 5 weld joints are secured to 5 corresponding cylindrical inserts 52. It will be understood by those knowledgeable in the art that the size and shape of the KOVAR® inserts can be modified to accommodate the type of welding used. The dimensions and locations of the KOVAR® inserts need simply be adapted to the location, depth and diameter of the laser beam weld joints used to secure the components of the aligning apparatus. Similarly, it may be easier in some circumstances to have a weld joint area 54 (shaded area) instead of individual inserts for each weld joint. The weld joint area 54 can be shaped as required to receive the weld joints and help secure the coupling apparatus. One of the advantage with using KOVAR® is its low thermal conductivity but also it is a good match with the thermal expansion coefficient of the matrix material of the baseplate (e.g. CuW). Other weldable materials (e.g. SILVAR®) can also be used—as long the thermal expansion coefficients mismatch is not too large. Similarly, AIN can be used for the baseplate instead of CuW.

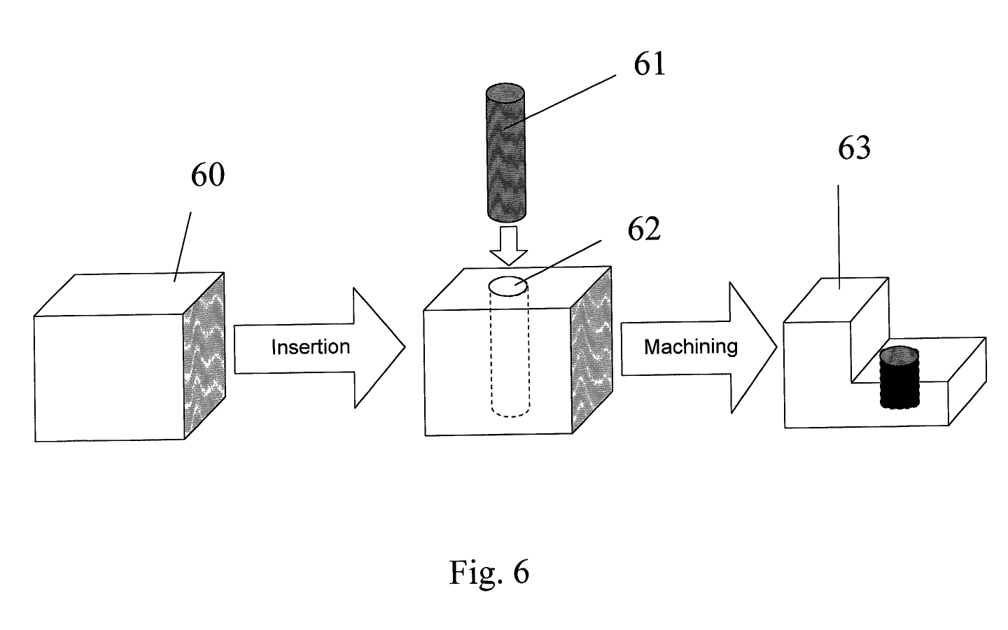

Referring now to FIG. 6, we have shown a block diagram illustrating the process for integrating KOVAR® inserts in a thermally conductive material such as CuW. This process is used for making what is known as Functionally graded materials (FGM). With reference to FIG. 6, a CuW body 60 can be produced by means of powder metallurgy (PM). This comprises the blending, molding and sintering of Copper and Tungsten powder. A cost effective CuW body can be produced and be modified as required.

The KOVAR® inserts 61 of various shapes and sizes can be inserted into a drilled or milled hole 62. The inserts can be fixed by brazing, for example with a Silver-Copper AgCu solder. The CuW body with KOVAR® inserts 63 can then be machined, grinded, polished, metallized, etc. to achieve the required shape of carrier design. A PM process is described in published patent application WO00/13823.

We claim:

1. A method of preparing a laser carrier baseplate for receiving an apparatus for optically coupling a high power laser to an optical fibre by means of laser beam welding, comprising the steps of:
a) identifying the location of weld joints required to secure said optical coupling apparatus to said carrier baseplate;
b) identifying the depth and diameter of said weld joints;
c) placing one or more low thermal conductivity insert at each weld joint; and
d) securing said low thermal conductivity insert to said weld joint.

2. A method as defined in claim 1, wherein said carrier baseplate is disposed on a Thermo Electric Cooler (TEC).

3. A method as defined in claim 2, wherein said carrier baseplate and said one or more low thermal conductivity inserts are produced by means of a functionally graded material manufacturing process.

4. A method as defined in claim 3, wherein said low thermal conductivity inserts are made of KOVAR®

5. A method as defined in claim 3, wherein the step of forming said carrier baseplate with said low thermal conductivity inserts comprises the steps of:
a) Creating a carrier baseplate by means of powder metallurgy;
b) Drilling into said carrier baseplate a receptacle to receive said low thermal conductivity insert;
c) Inserting and brazing said low thermal conductivity insert into said receptacle; and
d) Machining said carrier baseplate and low thermal conductivity insert to form said carrier baseplate with integral low thermal conductivity inserts.

6. A method as defined in claim 5, wherein said carrier baseplate is created by blending, molding and sintering Cu and W-powder.

7. A laser carrier baseplate for receiving and securing an apparatus for optically coupling a high power laser to an optical fiber, comprising:
a carrier base having a plurality of receptacles for receiving one or more low thermal conductivity inserts located and sized according to the depth and diameter of weld joints required for securing said apparatus to said laser carrier baseplate.

8. A laser carrier baseplate as defined in claim 7, wherein said carrier baseplate is attached to a Thermo Electric Cooler (TEC) template.

9. A carrier baseplate attached to a TEC as defined in claim 8, wherein said low thermal conductivity inserts are formed on said baseplate by means of a functionally graded material manufacturing process.

10. A carrier baseplate attached to a TEC as defined in claim 9, wherein said low thermal conductivity inserts comprises KOVAR®.
